(19) United States
(12) Patent Application Publication
(10) Pub. No.: US 2019/0354537 A1
(43) Pub. Date: Nov. 21, 2019

(54) System and Method for Increasing the Speed at Which Critical Safety Information is Provided or Accessed

(71) Applicant: James A. La Maire, Warren, NJ (US)

(72) Inventor: James A. La Maire, Warren, NJ (US)

(21) Appl. No.: 16/410,571

(22) Filed: May 13, 2019

Related U.S. Application Data
(60) Provisional application No. 62/672,806, filed on May 17, 2018.

(51) Int. Cl. G06F 16/27; G06F 16/29; G06F 16/2458; G06F 16/28

(52) U.S. Cl. CPC G06F 16/27; G06F 16/287; G06F 16/2465; G06F 16/29

(57) ABSTRACT

A cloud-based geographic information system (GIS) and method for increasing the speed at which safety critical information is provided or accessed that combines Crisis Mitigation, Sex Offender Management and Drug Free Zones into one system to provide enhanced community safety, wherein the system and method provide secure information collection, communication, and management in a manner that allows responders to make quicker assessments, which creates a safer environment for individuals in public communities, where data is visually represented/presented in the cloud-based GIS system in a manner that adds value and improves the ability of a user to make decisions related to safety quickly and effectively.

### CROSS-REFERENCE TO RELATED APPLICATION

This application is claims priority from U.S. Provisional Application Ser. No. 62/672,806 filed May 17, 2018, the content of which is incorporated herein by reference in its entirety.

### BACKGROUND OF THE INVENTION

### 1. Field of the Invention

The invention generally relates to the field of safety management and, more particularly, to a cloud-based geographic information system (GIS) and method for increasing the speed at which safety critical information is provided or accessed that combines Crisis Mitigation, Sex Offender Management and Drug Free Zones into one system to provide enhanced community safety.

### 2. Description of the Related Art

In certain situations, the ability to provide critical information quickly is important for safety purposes, i.e., the speed at which information is provided allows responders to make quicker condition assessments. Conventional systems and methods seek to meet this need, but merely address one aspect of community safety via Crisis Mitigation. However, these conventional systems and methods fail to address the needs presented by Sex Offender Management and Drug Free zones. Within Crisis Mitigation, the conventional systems and method do not enhance the speed of access to the information and do not optimize the entire workflow process.

For example, there are at least four aspects associated with providing community safety, e.g., School, Campus or Building Information Management, Sex Offender Management, Drug Free School & Park Zones and Crisis Mitigation.

With respect to School, Campus or Building Information Management, the storage and management of critical documents, crisis plans, maps, and other facility or campus information is vital. This provides the user security in knowing they are ready for any type of situation.

As for Sex Offender Management, the time-consuming process for managing the data for sex offenders can cause difficulty in keeping records accurate and up-to-date. This can lead to issues such as meeting statutory requirements, improper notification of potentially impacted people/organizations and even losing track of the offender.

Regarding Drug Free School & Park Zones, having accurate and properly documented information means less prosecutorial issues at criminal trials. As for Crisis Mitigation, with respect to time critical information availability a missed opportunity, caused by lost time, could result in the loss of lives. It is known to perform or implement each of these processes individually. However, while the foregoing processes are currently being performed individually, they are not performed in the most efficient manner possible.

### SUMMARY OF THE INVENTION

Disclosed is a cloud-based geographic information system (GIS) and method for increasing the speed at which safety critical information is provided or accessed that combines Crisis Mitigation, Sex Offender Management and Drug Free Zones into one system to provide enhanced community safety. The disclosed system and method provide secure information collection, communication, and management in a manner that allows responders to make quicker assessments, which creates a safer environment for individuals in public communities. In accordance with the invention, data is visually represented/presented in the cloud-based GIS system in a manner that adds value and improves the ability of a user to make decisions related to safety quickly and effectively.

The cloud-based GIS system and method enhances the workflow, and speed of access to information that is critical for human safety in public communities. The cloud-based GIS system and method comprises a turn-key cloud based GIS solution that adds value to information (data). In accordance with the invention, the value of the captured data is increased because the data is usable across multiple processes, such as “Sex Offender Management”, “Crisis Mitigations”, and “Drug Free School and Park Zones” implementation. Thus, the cloud-based GIS system and method combines at least three components to maximize information usage. That is, within a cloud based GIS system (i) Crisis Mitigation, (ii) Sex Offender Management and (iii) Drug Free School Zone management are combined into one solution such that safety within these type of communities is enhanced.

For example, with respect to Crisis Mitigation, a “Crisis Mitigation” module provides proactive planning for the safety of everyone in a community. This module allows for easy retrieval of Crisis Plans to make them digitally dynamic. Rapidly providing the right information to the hands of those managing an incident is critical when seeking to save lives. The cloud-based GIS system and method enhances the speed at which this information is provided.

Sex Offender Management is enhanced because the “Sex Offender” module provides a way to easily maintain information while automatically generating notification letters and walk lists.

As for implementing Drug Free School & Park Zones, including a module pursuant to this requirement provides the ability to print out a graphical map of an arrest area for presentation at criminal trials. As such, typically the location, photos, and other key information are captured/recorded at the time of arrest to assist in properly building or establishing a case. The knowledge of whether the address at which an accused is arrested is within a drug free zone allows accuracy of charges at the time of arrest.

It should also be noted the cloud-based GIS system and method in accordance with the invention, enhances School, Campus or Building Information Management by increasing the value of captured data because this data can be used across all the modules. As such, both speed and breadth of information is available for a wide audience based upon their role and responsibility.

Other objects and features of the present invention will become apparent from the following detailed description considered in conjunction with the accompanying drawings. It is to be understood, however, that the drawings are designed solely for purposes of illustration and not as a definition of the limits of the invention. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

The invention is explained below in greater detail with respect to exemplary embodiments that refer to the enclosed figures, in which:

FIG. 1 is a schematic block diagram of the system for increasing the speed at which critical safety information is provided or accessed;

FIG. 2 is a schematic block of the relevant section of the system of FIG. 1 that are accessed pursuant to set up of the system in accordance with the invention;

FIG. 3 is a schematic block of the system of FIG. 1 that is access pursuant to setting up the linux server in accordance with the invention;

FIG. 4 is a schematic block diagram of the school, campus and building information module in accordance with the invention;

FIG. 5 is a screen capture of the management screen presented during the school, campus and building information module of FIG. 4;

FIG. 6 is a schematic block diagram of the sex offender information module in accordance with the invention;

FIG. 7 is an exemplary screen capture of a school walk list in accordance with the invention;

FIG. 8 is a screen capture of the management screen presented via the sex offender information module of FIG. 6;

FIG. 9 is a schematic block diagram of the drug-free school & park zones module in accordance with the invention;

FIG. 10 is a screen capture of the management screen for documenting information related to activities via the drug-free school & park zones module of FIG. 9;

FIG. 11 is a screen capture of an input screen presented pursuant to documenting an arrest at a drug free sight in accordance with the invention;

FIG. 12 is a graphical illustration of a drug free zone map presented on a screen via the drug-free school & park zones module of FIG. 6;

FIG. 13 is a schematic block diagram of crisis mitigation in accordance with the invention;

FIG. 14 is a screen capture of an input screen presented pursuant to crisis mitigation in accordance with the invention;

FIG. 15 is a screen capture of an enhanced “smart notification” in accordance with the invention;

FIG. 16. Is a screen capture of an exemplary crisis mitigation control board in accordance with the invention;

FIG. 17 is a screen capture of an input screen for documenting each grid point at which a crisis occurs in accordance with the invention; and

FIG. 18 is a flowchart of the method for increasing the speed at which critical safety information is provided or accessed.

### DETAILED DESCRIPTION OF THE EXEMPLARY EMBODIMENTS

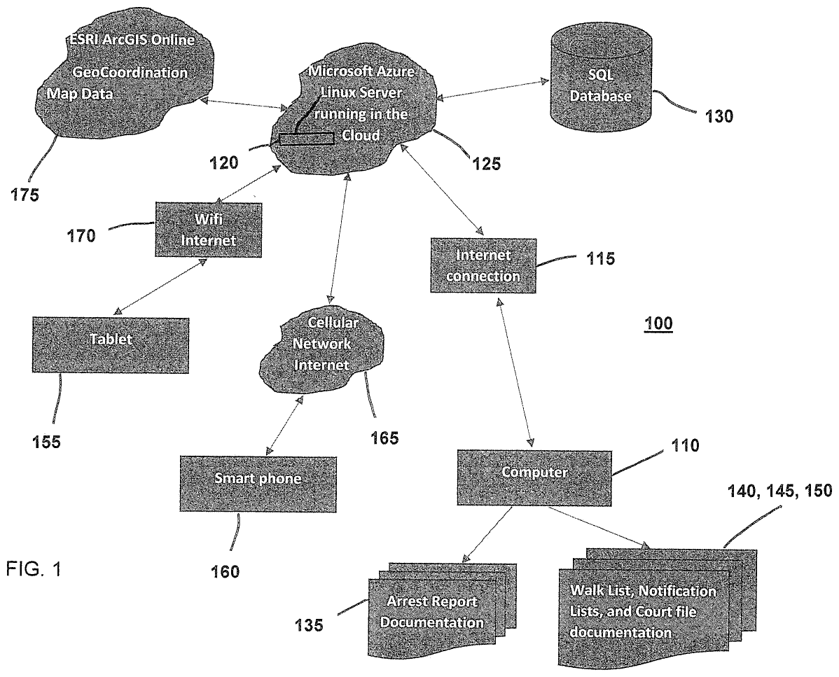

FIG. 1 is a schematic block diagram of the system 100 for increasing the speed at which critical safety information is provided or accessed. With reference to FIG. 1, the system 100 includes a conventional computer 110 that interfaces via a standard internet connection 115 to a Linux server 120 resident in a cloud computing environment 125. Generally, cloud computing is the on demand availability of computer system resources, especially data storage and computing power, without direct active management by the user. The computer 110 provides the ability to access various levels (layers) of documentation stored at a Structured Query Language (SQL) database 130, such as arrest report documentation 135, a walk list 140, notification lists 145 and court file documentation 150.

With further reference to FIG. 1, the system 100 additionally includes mobile computing devices, such as at least one tablet style computer 155 and at least one smartphone 160. Also shown is a cellular network 165 that implements cellular network technology pursuant to supporting a hierarchical structure formed by a base transceiver station (BTS), mobile switching center (MSC), location registers and public switched telephone network (PSTN), each of which is not shown for purposes of clarity. The cellular network 165 provides the smartphone 160 with access to the Linux server 120. The WiFi network 170 provides the at least one tablet style computer 155 with access to the Linux server 120. One type of Linux server is the Azure Virtual Server manufactured by Microsoft Corporation.

The system 100 includes a “School Campus or Building Information Management” module, a “Crisis Mitigation Management” module, a “Drug Free Schools & Park Zones” module, a “Sex Offender Management” module, each of which is discussed subsequently. Each of these modules interfaces with the SQL database 130 that stores information, such as building layouts/Floor plans, Contact Information, Crisis Plans, Photos, Arrest Documentation, Sex Offender Details and Addresses of places such as parks, schools and organizations. Each module also interfaces with the Esri ArcGIS online database 175, which is a complete, cloud-based mapping platform that allows a user to create and share geographical maps.

In accordance with the invention, prior to implementation of the method several steps are necessary to setup the information needed for optimal performance of the invention. Certain aspects of the data or information is publicly available (e.g., list of schools and their addresses) while other information must be collected from clients or third party sources. Thus, the computer 110 includes ArcGIS Desktop (Basic) that is used to setup the geographic information system (GIS) layers and information in the Esri ArcGIS online database 175. ArcGIS is a geographic information system (GIS) manufactured by the Esri Corporation that is used to work with maps and geographic information. ArcGIS is used for creating and using maps, compiling geographic data, analyzing mapped information, sharing and discovering geographic information, using maps and geographic information in a range of applications, and managing geographic information in a database.

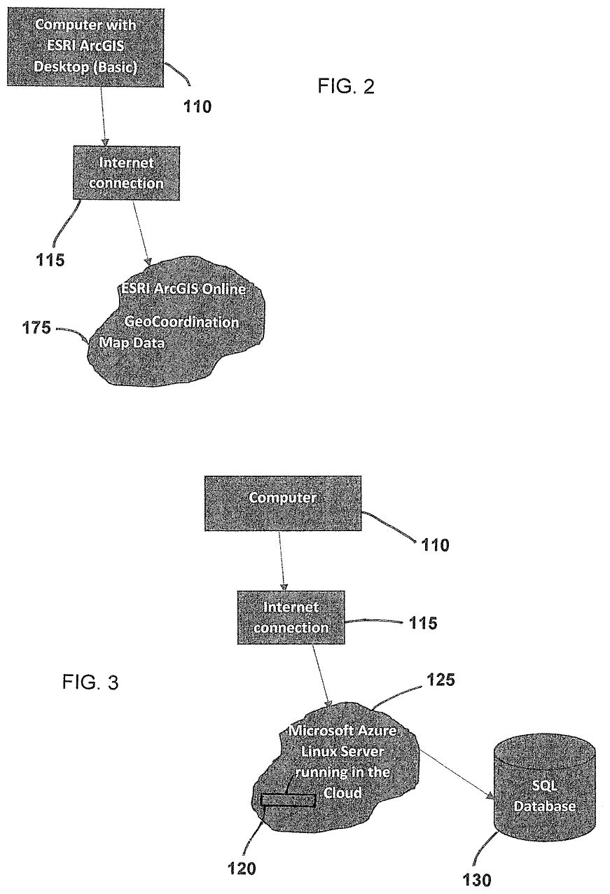

Accordingly, with reference to FIGS. 2 and 3, GIS layers are loaded into the Esri ArcGIS online database 175 via the internet connection 115. These layers include Geolocated Hi-resolution Imagery, Schools & Parks Map with Geolocated property outlined, Drug Free Zones Mapping with borders to indicate restricted areas, Emergency staging area Maps, a Quasi-military Grid and a Geolocated Building Door and entry 1^{st} floor plan.

The Azure Linux Server 120 running in the cloud 125 includes another database (not shown) that stores further data. This information is either batch loaded or manually input from the computer 110 to setup the further database. It should be understood that an end-user will be able to update the information after the initial load. The further data loaded into the Azure Linux Server 120 includes School/Campus/Business Information, User Roles and Access, Emergency Contacts, Responder Teams, Crisis Plans, Floor plans, Engineering Drawings and/or Sex Offender details.

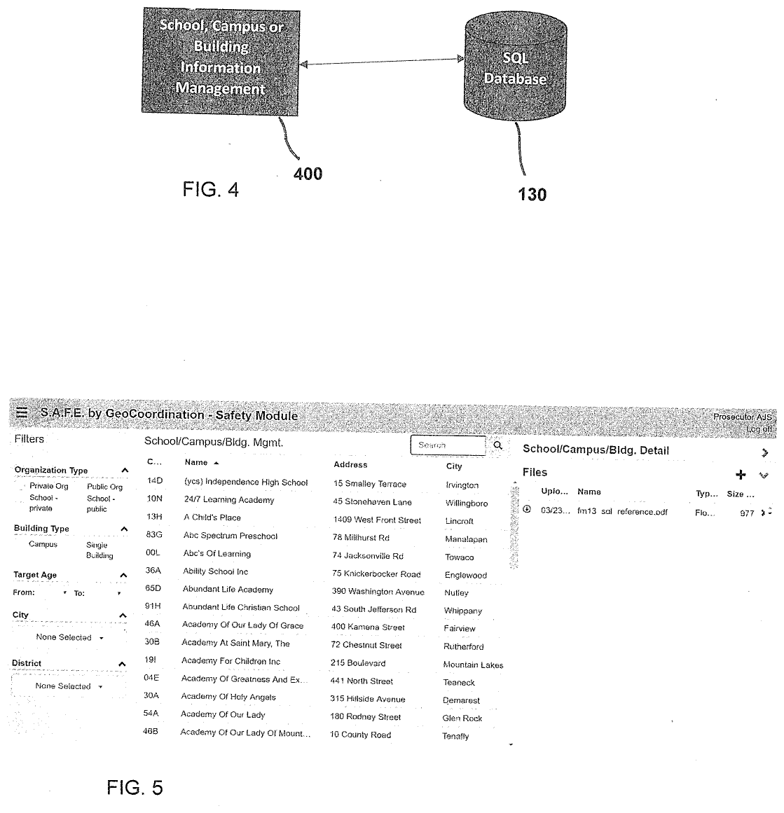

FIG. 4 is a schematic block diagram of the school, campus and building information module 100 in accordance with the invention. Here, the system and method advantageously increase the value of captured data because it can be used across multiple processes. The system and method provide both speed of access and breadth of information for a wide audience. The audience for the information can include individuals such as a criminal prosecutor or District Attorney, an arresting law enforcement officer, administrative support staff, police, EOM and first responders. Stored at the SQL database 130 is information pertaining to building layouts and floor plans, contact information, crisis plans, and addresses of schools and organizations.

The school, campus and building information management module 400 allows for the creation and maintenance of information that is needed throughout the system 100. The information can be entered either through a screen interface (see FIG. 5) or uploaded directly to the database via a spreadsheet interface (not shown). The storage and management of critical documents, plans, maps, and other facility or campus information is vital. This gives the user security in knowing they are ready for any type of situation. The value of the data that is captured is thus increased because it can be used across multiple processes by multiple people in different roles (e.g., Prosecutors, an Arresting Officer, Administrative support staff, Police, EOM and/or First Responders).

The following exemplary information can be provided in accordance with the invention.
Schools—Public and Private
Campuses—building on the campus—Schools or corporations
Businesses—small or large
Hospitals and Medical Centers
Malls
Sports venues
Community Organizations

The following exemplary descriptive information is provided in accordance with the invention.
Organization Name
Type of organization
Address
City
County
Campus or Single Building
Building Identifier
Building Name
Special notes
School age range and grade range
Primary and Secondary contacts
Name
Title
Email
Phone number

The following is uploaded via a data interface (not shown) provided at the internet connection 115.
Floor plans—Strategically named to appear in the proper order
Mechanical drawings
   HVAC
   Electric
   Plumbing
Room Checklist in a spreadsheet format
Crisis Plans

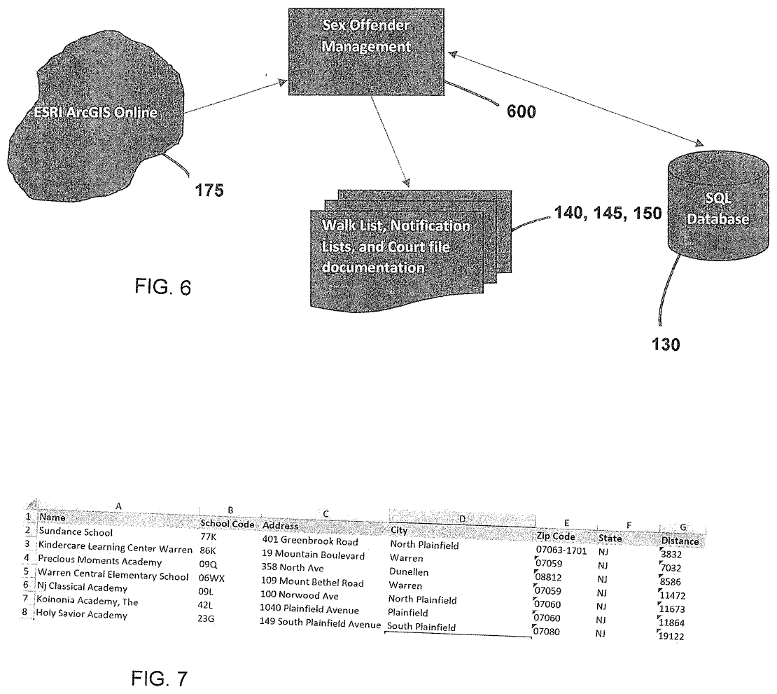

FIG. 6 is a schematic block diagram of the sex offender management module 600 in accordance with the invention. The system and method provides a way to easily maintain information while automatically generating notification letters and walk lists. Here, the “Sex Offender Management” module 600 saves time with respect to performing research on sex offenders. Reports and information updates to State or Government entities are performed in an automated manner, where the addition and update of information is performed easily and is maintained with ease. Moreover, the system and method automatically generates notification letters and walking lists for statutorily designated recipients. With reference to FIG. 6, this module 600 accesses GIS layers related to schools and parks, as well as community organizations via the Esri ArcGIS online database 175.

Providing sex offender information management improves the workflow on searching, maintaining and managing all data relevant to surrounding sex offenders. Users can utilize a view mode when performing global searches or when using specific filters. Users can also use an edit mode when creating or updating sex offender data.

The following categories of information can be easily edited and maintained.
Personal information
   1. Registration Number
   2. Full name
   3. Gender
   4. Race
   5. Date of birth
   6. Tier level
   7. Target age range
   8. Height
   9. Weight
   10. Hair color
   11. Eye color
   12. Picture with date taken
   13. Tier
   14. Home address notification radius
   15. Employment address notification radius
Distinguishing features
Offenses
Home address history
Employment history
Education history
Vehicle registrations

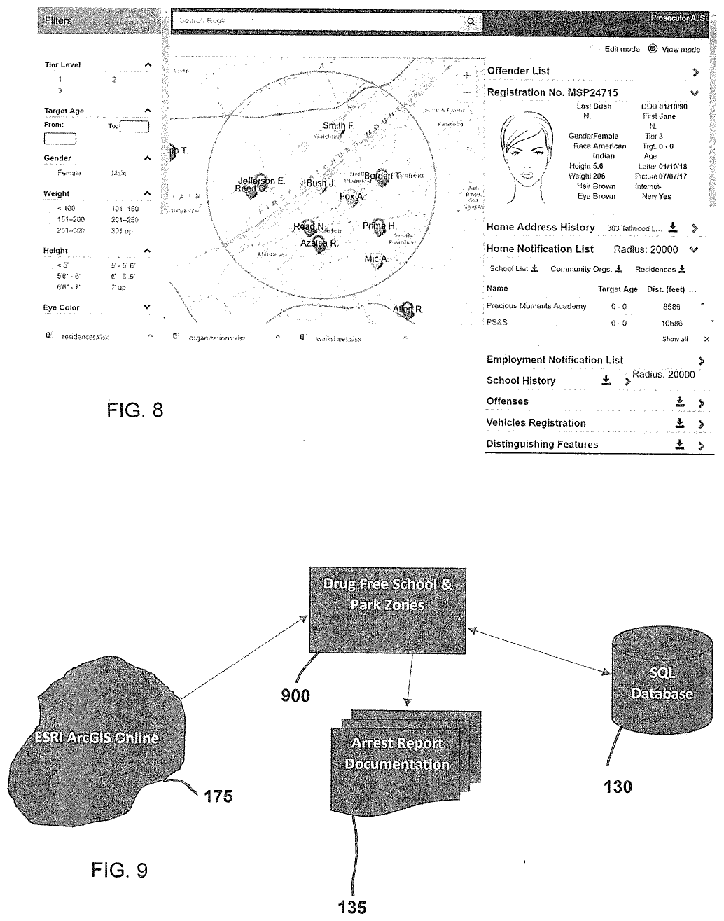

The system and method provides automatic generation of notification letters for Schools, Community Organizations and Residences based upon the notification radius. In accordance with the invention, it is easy to download the automatically created walk lists (see FIG. 8) as spreadsheet files. Moreover, automated reporting and information updates to State entities (where required by law) are provided in accordance with the invention.

Furthermore, searches of the SQL database 130 are easily performed to find different offenders that match certain criteria. As a result, time associated with any necessary research is minimized. The criteria includes the following exemplary information.
Tier
Age range
Gender
Weight range
Height
   Eye color
   Hair color
   Race

The search results are displayed on a map, as illustrated in FIG. 8. If an individual offender is selected, the display illustrates that selected offender in the center of a defined radius. It is also possible to print the displayed information as part of a maintained file, which documents the offender information.

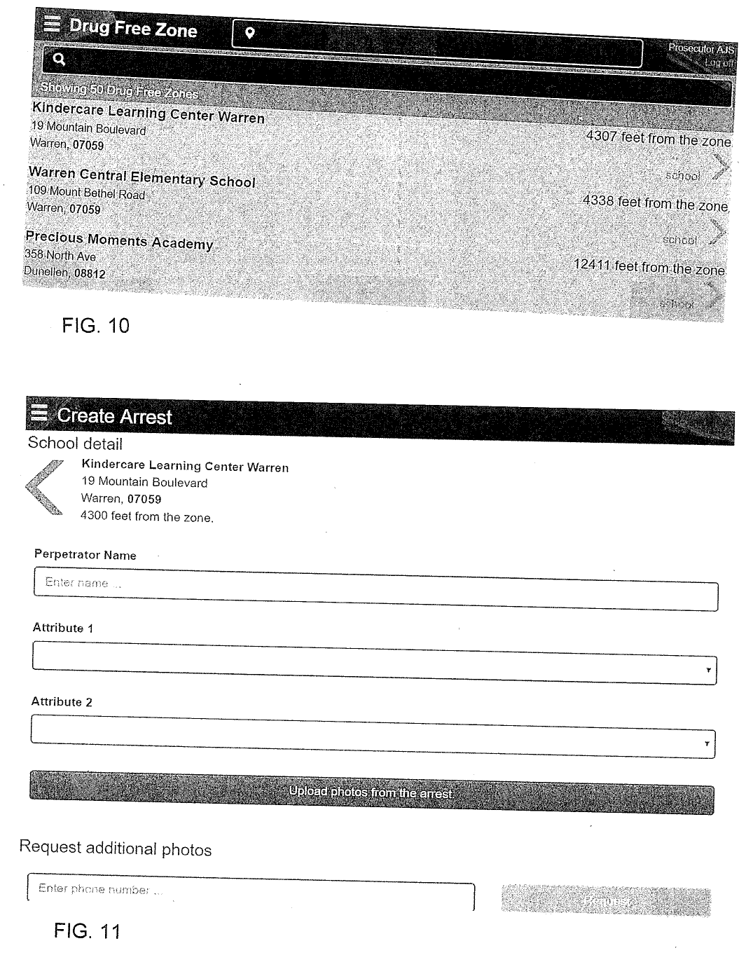

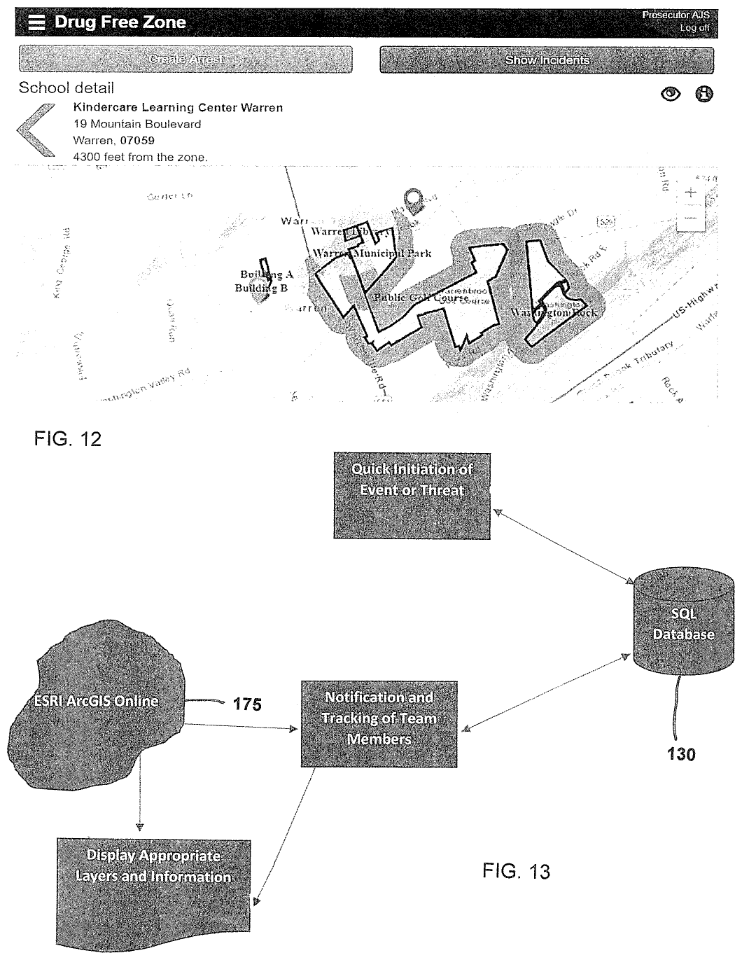

FIG. 9 is a schematic block diagram of drug-free school & park zones module 900 in accordance with the invention. The system and method provides the ability to document information related to activities in school zones (see FIG. 10). Having accurate and properly documented information means less issues at trial. That is, having accurate and properly documented information provides credible evidence that can be produced during criminal trials (see FIG. 11). A module 900 for providing drug free school and parking zones in accordance with the invention provides the ability to print out a graphical map of an arrest area for presentation at trial (se FIG. 12). The “Drug Free School & Park Zones” module provides the ability to print out the graphical map of an arrest area for presentation at trial. In order to accomplish this, location, photos, and other key information are captured at the time of arrest to assist in properly building a criminal case. Knowledge of whether or not the above-mentioned addresses are within a drug free zone enhances the accuracy of potential charges for officers at the time of arrest.

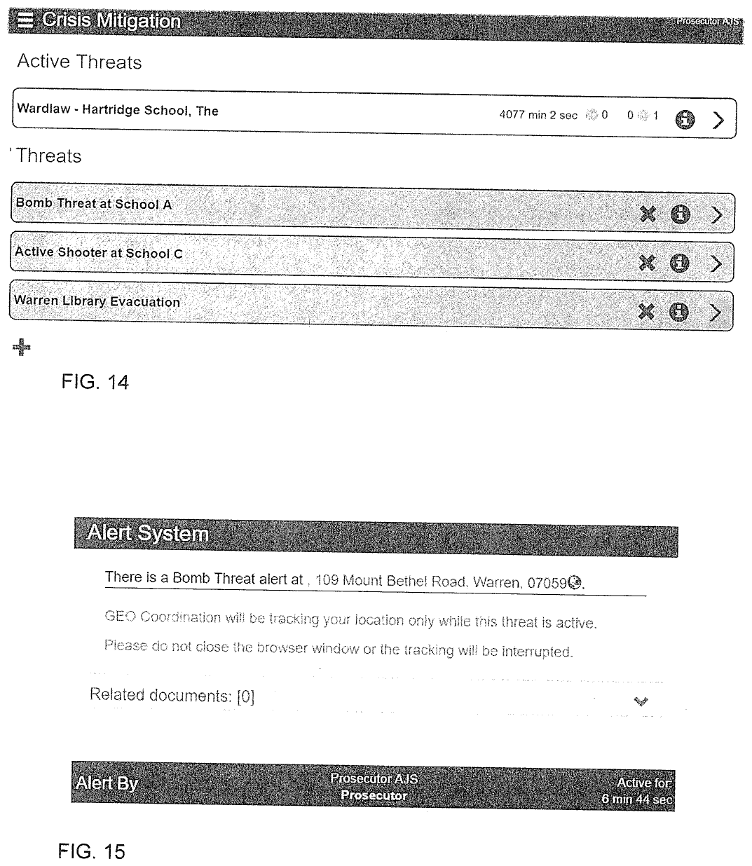

FIG. 13 is a schematic block diagram of crisis mitigation in accordance with the invention. Crisis mitigation includes proactive planning for the safety of individuals within a community. Here, “Crisis Plans” are easily retrievable from the SQL database 130 to make them dynamic. Critical to saving lives is the ability to rapidly forward the correct information to individuals responsible for responding to and managing an incident. As such, the method entails “Rapid Threat Initiation”. Here, a location is selected, a team is selected, and the type of threat is defined via the exemplary input screen (see FIG. 14) that is presented pursuant to crisis mitigation in accordance with the invention. The threat can be saved as a template to be used in the future to speed up the creation of a similar threat event. The layers that are accessible at the Esri ArcGIS online database 175 include Hi-res imagery, school, emergency staging areas, quasi-military grids and “tracked feet on the ground” teams. The information stored at the SQL database 130 includes crisis management plans, building layouts/floor plans, a floor by floor—room checklist, mechanical drawings, contact information including “create teams” and “create users” and addresses of places, such as schools, campuses and buildings.

The system and method provides enhanced “Smart Notification” and tracking of team members (see FIG. 15). Thus, within the crisis management process, a secure token based notification system is utilized. Here, short message system (SMS) messages, i.e., text messages, constitute one form of notification that can be used. The text message can contain a security token that allows a user to securely access time critical information. Another notification method is an email message, where the message can contain a link URL with an attached token that allows the user to securely access time critical information. It should be understood both systems allow a user to click on a hyperlink that forwards the user to a web-based application, and that the tokens are unique to each user.

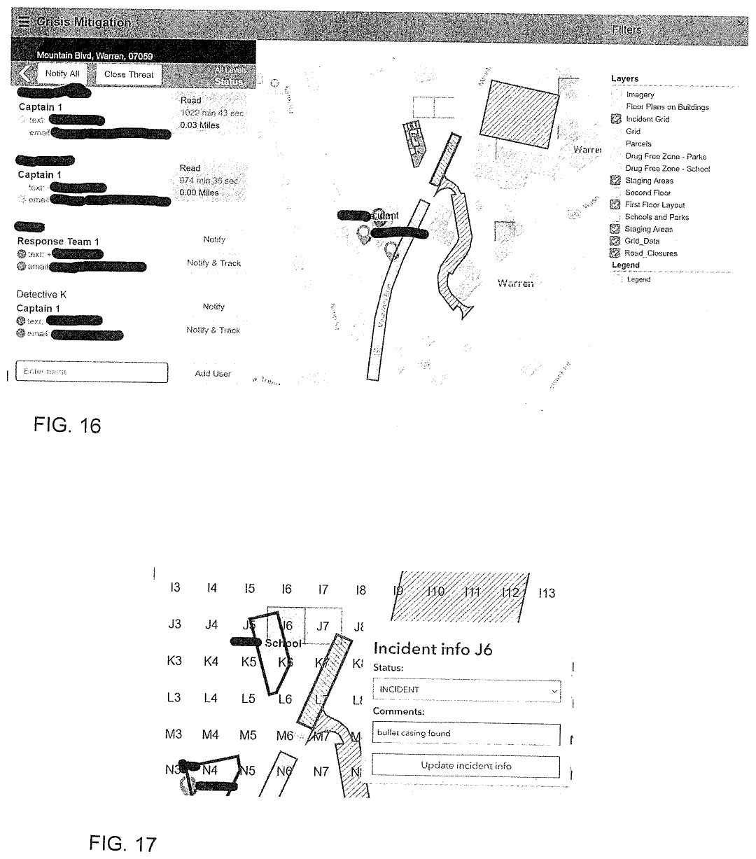

Appropriate layers and information are displayed on a “Command Center” screen (see FIG. 16). The displayed information can include information such as hi-resolution imagery, pre-defined staging areas, a quasi-military grid, a “tracked feet” on the ground team, floor plans and building zones visible on an incident map. It should be understood the method and system provides the ability of team members to document each grid point (see FIG. 17). In addition, real-time updates can be viewed by all individuals with the authority to access the information.

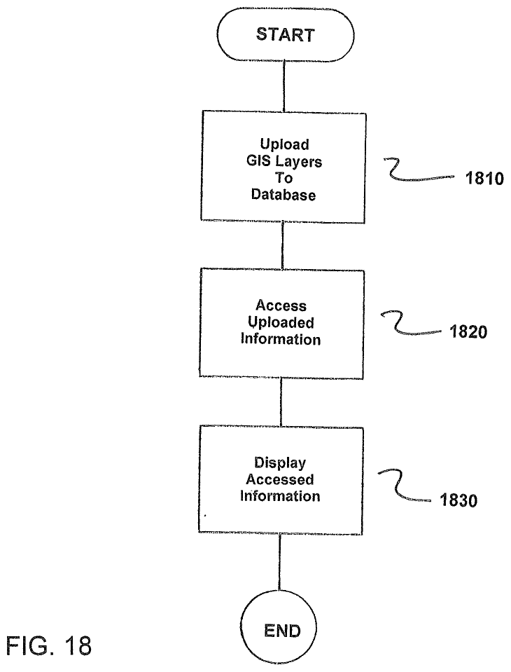

FIG. 18 is a flowchart of the method for increasing the speed at which critical safety information is provided or accessed. The method comprises uploading, from a computer 110 interfaced via a standard internet connection 115 to the server 120 disposed in the cloud computing environment 125, geographic information system (GIS) layers to an ArcGIS Online database 175 via the internet connection 115, as indicated in step 1810. The uploaded information is accessed via at least one computing device, as indicated in step 1820. Next, the accessed information is displayed based on accesses to the GIS layers uploaded to the ArcGIS Online database 175, as indicated in step 1830.

In sum, the system and method of the invention provides rapid access to critical information with a minimal number of steps, where secure tokens are used via communication gateways. Moreover, the automated creation and documentation of reports for sex offender management results in an extensive reduction in the time expended by individuals charged with this task. Additionally, future reports are provided to document and maintain compliance with regulatory agencies.

The system and method of the invention advantageously utilize captured information to improve other processes for community safety. Here, all safety information needed for the following processes are managed, i.e., Crisis Mitigation, Sex Offender Management, Drug Free Zones, and School, Campus and Building Information Management. The multi process use of the data provided by the processes adds value to the time to capture the information. There are other advantages provided by the system and method of the invention in that speed and secure access to the information is highly valuable, and the automation of the reporting capability for Sex Offender Management advantageously saves administrative staff many hours associated with the tedium of performing this task.

Thus, while there have been shown, described and pointed out fundamental novel features of the invention as applied to a preferred embodiment thereof, it will be understood that various omissions and substitutions and changes in the form and details of the methods described and the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. A system for increasing the speed at which critical safety information is provided or accessed, the system comprising:
a server disposed in a cloud computing environment;
a computer which interfaces via a standard internet connection to the server disposed in the cloud computing environment;
a database storing information comprising documentation;
at least one mobile device for accessing the server disposed in the cloud computing environment via a cellular network;
at least one tablet computer which accesses the server disposed in the cloud computing environment via at least a WiFi communication network; and
an ArcGIS online database which stores geographic information system (GIS) layers.

2. The system of claim 1, further comprising:
a School Campus or Building Information Management module;
a Crisis Mitigation Management module;
a Drug Free Schools & Park Zones module; and
a Sex Offender Management module.

3. The system of claim 2, wherein the modules each interface to the ArcGIS Online database.

4. The system of claim 1, wherein the stored information comprises at least one of building layouts/Floor plans, Contact Information, Crisis Plans, Photos, Arrest Documentation, Sex Offender details and addresses of parks, schools and organizations.

5. The system of claim 1, wherein the computer 110 includes an ArcGIS Desktop software package which is utilized to setup the GIS layers and other information in the ArcGIS Online database.

6. The system of claim 1, wherein the GIS layers include Geolocated Hi-resolution Imagery, Schools & Parks Map with Geolocated property outlined, Drug Free Zones Mapping with borders to indicate restricted areas, Emergency staging area Maps, a Quasi-military Grid and a Geolocated Building Door and entry first floor plan.

8. The system of claim 1, wherein the server stores further information which is one of batch loaded or manually input from the computer to setup a further database within the server.

8. The system of claim 7, wherein the server is an Azure Linux server.

9. The system of claim 8, wherein the further information includes School/Campus/Business Information, User Roles and Access, Emergency Contacts, Responder Teams, Crisis Plans, Floor plans, Engineering Drawings and/or Sex Offender details.

10. A method for increasing the speed at which critical safety information is provided or accessed, the method comprising:
uploading, from a computer interfaced via a standard internet connection to a server disposed in a cloud computing environment, geographic information system (GIS) layers to a database via the internet connection;
accessing via at least one computing device the uploaded information; and
displaying the accessed information based on accesses to the GIS layers uploaded to the database.

11. The method of claim 10, wherein the database stores information comprising at least one of building layouts/Floor plans, Contact Information, Crisis Plans, Photos, Arrest Documentation, Sex Offender details and addresses of parks, schools and organizations.

12. The method of claim 10, wherein the computer includes an ArcGIS Desktop software package which is utilized to setup the GIS layers and other information in the database.

13. The method of claim 10, wherein the GIS layers include Geolocated Hi-resolution Imagery, Schools & Parks Map with Geolocated property outlined, Drug Free Zones Mapping with borders to indicate restricted areas, Emergency staging area Maps, a Quasi-military Grid and a Geolocated Building Door and entry first floor plan.

14. The method of claim 10, wherein the server is an Azure Linux server.

15. The method of claim 14, wherein the Azure Linux Server stores further information which is one of batch loaded or manually input from the computer to setup a further database within the Azure Linux Server

16. The method of claim 16, wherein the further information includes School/Campus/Business Information, User Roles and Access, Emergency Contacts, Responder Teams, Crisis Plans, Floor plans, Engineering Drawings and/or Sex Offender details.

17. The method of claim 1, wherein the database comprises an ArcGIS online database.
